(19) United States
(12) Patent Application Publication
(10) Pub. No.: US 2023/0180044 A1
(43) Pub. Date: Jun. 8, 2023

(54) METHOD FOR ENHANCING WIRELESS COMMUNICATION DEVICE MEASUREMENTS

(71) Applicant: ZTE CORPORATION, Shenzhen (CN)

(72) Inventors: Ting LU, Shenzhen (CN); Li NIU, Shenzhen (CN); Bo DAI, Shenzhen (CN); Xiubin SHA, Shenzhen (CN)

(21) Appl. No.: 18/104,834

(22) Filed: Feb. 2, 2023

Related U.S. Application Data
(63) Continuation of application No. PCT/CN2020/107715, filed on Aug. 7, 2020.

(51) Int. Cl. H04W 24/10; H04W 24/08

(52) U.S. Cl. CPC H04W 24/10; H04W 24/08

(57) ABSTRACT

Presented are systems and methods for enhancing wireless communication device measurements. A wireless communication device may receive a configuration of time information from the wireless communication node. The configuration may comprise a configuration of time information for measurements to be performed by the wireless communication device. The wireless communication device may perform at least one of the measurements according to the configuration.

### CROSS-REFERENCE TO RELATED APPLICATION

This application claims the benefit of priority under 35 U.S.C. § 120 as a continuation of International Patent Application No. PCT/CN2020/107715, filed on Aug. 7, 2020, the disclosure of which is incorporated herein by reference in its entirety.

### TECHNICAL FIELD

The disclosure relates generally to wireless communications, including but not limited to systems and methods for enhancing wireless communication device measurements.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive a configuration of time information from the wireless communication node. The configuration may comprise a configuration of time information for measurements to be performed by the wireless communication device. The wireless communication device may perform at least one of the measurements according to the configuration.

In some embodiments, the measurements may comprise at least one of intra-frequency measurement, inter-frequency measurement, measurement of neighboring cells, or measurement of radio access technology (RAT). In some embodiments, the configuration may indicate to use a fixed time interval between the measurements to be performed by the wireless communication device. In some embodiments, the configuration may indicate to use a time interval that increases or decreases between successive measurements to be performed by the wireless communication device.

In some embodiments, the wireless communication device may initiate a measurement for each time interval in which a quality of a serving cell fails to satisfy a threshold value. In some embodiments, the configuration may indicate to start a next time interval at a time instance at which a measurement of a current time interval is complete. In some embodiments, the wireless communication device may start or restart a timer for the next time interval, at the time instance at which the measurement of the current time interval is complete. In some embodiments, the wireless communication device may initiate one of the measurements according to the configuration, during an opportunity for discontinuous reception (DRX) in a DRX cycle.

In some embodiments, the wireless communication device may initiate one of the measurements according to the configuration, and during a downlink gap. In some embodiments, the wireless communication device may receive at least one threshold value from the wireless communication node. In some embodiments, the wireless communication device may perform the measurements according to the configuration when at least one parameter exceeds the at least one threshold value. In some embodiments, the at least one parameter may comprise at least one of a repetition number, a modulation order, a transport block size, a number of transmitted negative-acknowledgement (NACK) messages.

In some embodiments, the wireless communication device may determine to stop or start at least one of the measurements if one or more conditions are satisfied. In some embodiments, the one or more conditions that are satisfied may comprise at least one of the wireless communication device obtains measurement results for all neighbor cells, the wireless communication device obtains measurement results for some of the neighbor cells identified by the wireless communication device, the wireless communication device obtains measurement results for neighbor cells identified or configured by the wireless communication device, the wireless communication device obtains measurement results for neighbor cells with strongest signal strengths, or the wireless communication device obtains measurement results for neighbor cells which indicate that a cell quality associated with the neighbor cells is higher than a quality of a serving cell of the wireless communication device.

In some embodiments, the time information for the measurements may include at least one of a time interval between at least two of the measurements, a time interval or duration in which there is no measurement, or time duration for at least one of the measurements. In some embodiments, the time interval may be configured to increase or decrease between successive measurements, according to a result of at least one prior measurement of the measurements.

At least one aspect is directed to a system, method, apparatus, or a computer-readable medium. A wireless communication node may send a configuration of time information to the wireless communication device. The configuration may comprise a configuration of time information for measurements to be performed by the wireless communication device. The wireless communication device may perform at least one of the measurements according to the configuration.

In some embodiments, the measurements may comprise at least one of intra-frequency measurement, inter-frequency measurement, measurement of neighboring cells, or measurement of radio access technology (RAT). In some embodiments, the configuration may indicate to use a fixed time interval between the measurements to be performed by the wireless communication device. In some embodiments, the configuration may indicate to use a time interval that increases or decreases between successive measurements to be performed by the wireless communication device.

In some embodiments, the configuration may indicate a time interval. The wireless communication device may perform neighbor cell measurement(s) at least once during said time interval. For example, the wireless communication device may continuously start and/or restart a timer (e.g., Tₘₑₐₛᵤᵣₑ) using said time interval. At the starting point of the timer, the wireless communication device may evaluate the quality of the serving cell. If at least one trigger condition (e.g., the quality of the serving cell deteriorates and/or other conditions) is fulfilled, the wireless communication device may initiate the performance of the neighbor cell measurement(s). When at least one stop condition is fulfilled, the wireless communication device may stop/suspend the time measurement(s). If the start and/or restart timer is running (e.g., Tₘₑₐₛᵤᵣₑ has not expired), the wireless communication device may suspend the performance of measurement(s) before the timer expires. For example, the wireless communication device may perform one or more legacy processes in connected mode. If the quality of the serving cell is acceptable at the restart point, the wireless communication device may skip/omit one or more neighbor cell measurement(s) until the timer expires. In some embodiments, the measurements of the wireless communication device may be distributed on the time line.

In some embodiments, the wireless communication device may initiate a measurement for each time interval in which a quality of a serving cell fails to satisfy a threshold value. In some embodiments, the configuration may indicate to start a next time interval at a time instance at which a measurement of a current time interval is complete. In some embodiments, the wireless communication device may start or restart a timer for the next time interval, at the time instance at which the measurement of the current time interval is complete. In some embodiments, the wireless communication device may initiate one of the measurements according to the configuration, during an opportunity for discontinuous reception (DRX) in a DRX cycle.

In some embodiments, the wireless communication device may initiate one of the measurements according to the configuration, and during a downlink gap. In some embodiments, the wireless communication node may send at least one threshold value to the wireless communication device. In some embodiments, the wireless communication device may perform the measurements according to the configuration when at least one parameter exceeds the at least one threshold value. In some embodiments, the at least one parameter may comprise at least one of a repetition number, a modulation order, a transport block size, a number of transmitted negative-acknowledgement (NACK) messages.

In some embodiments, the wireless communication device may determine to stop or start at least one of the measurements if one or more conditions are satisfied. In some embodiments, the one or more conditions that are satisfied may comprise at least one of the wireless communication device obtains measurement results for all neighbor cells, the wireless communication device obtains measurement results for some of the neighbor cells identified by the wireless communication device, the wireless communication device obtains measurement results for neighbor cells identified or configured by the wireless communication device, the wireless communication device obtains measurement results for neighbor cells with strongest signal strengths or the wireless communication device obtains measurement results for neighbor cells which indicate that a cell quality associated with the neighbor cells is higher than a quality of a serving cell of the wireless communication device.

In some embodiments, the time information for the measurements may include at least one of a time interval between at least two of the measurements, a time interval or duration in which there is no measurement, or time duration for at least one of the measurements. In some embodiments, the time interval may be configured to increase or decrease between successive measurements, according to a result of at least one prior measurement of the measurements.

In some embodiments, the systems and methods presented herein may include an approach for synchronizing/configuring the communication between the wireless communication device and the wireless communication node or network (e.g., via a configured time duration). In some embodiments, the communication may comprise a communication associated with terminating/ending/completing one or more measurement(s). For example, when the measurements are initiated, the wireless communication device and the wireless communication node may complete/finalize the measurements within the configured time duration.

In some embodiments, the wireless communication device may perform intra-frequency measurements, inter-frequency measurements, and/or other measurements within a fixed time interval (or time duration). In some embodiments, the time interval may gradually increase/lengthen or decrease/shorten compared to the time interval of the previous measurement(s). In some embodiments, a starting/initial location of a second time interval may be different from a starting/initial location of a first time interval. For example, the wireless communication device may start/initiate or restart/reinitiate a timer after one or more measurements (e.g., intra-frequency measurements, inter-frequency neighbor cell measurements, or other measurement) have been completed. Therefore, the time interval may correspond to a time duration for suppressing measurements.

In some embodiments, the wireless communication device may determine to stop at least one of the measurements if one or more conditions are satisfied/fulfilled. In some embodiments, the conditions may comprise that the wireless communication device obtains/receives/completes the measurement results for one or more neighbor cells in a same frequency and/or different frequencies. In some embodiments, the conditions may comprise that the wireless communication device obtains/receives/completes the measurement results for some neighbor cells by implementation. In some embodiments, the conditions may comprise that the wireless communication device obtains the measurement results for the configured neighbor cells if the network provides/specifies a neighbor cell list. The configured neighbor cells may be in the same/corresponding frequency and/or different frequencies. In some embodiments, the conditions may comprise that the wireless communication device obtains the measurement results for the neighbor cells with the strongest/highest signal strength. The neighbor cells may be in the same/corresponding frequency and/or different frequencies.

In some embodiments, the wireless communication device may perform/acquire/obtain one or more measurements for one or more neighbor cells on/during a fixed time interval (or duration). In some embodiments, the wireless communication device may perform one or more measurements for one or more neighbor cells on/during a time interval. The time interval may gradually increase or decrease compared to the time interval of the previous measurement(s). In some embodiments, the wireless communication device may use/enable a connected mode DRX. Responsive to using the connected mode DRX, the wireless communication device may perform/obtain the measurement(s) during/within the overlap between the configured time interval and the opportunity for DRX in the DRX cycle.

In some embodiments, the wireless communication device may use a downlink gap to perform one or more measurements. The wireless communication device may perform the measurement(s) within/during the overlap between the configured time interval and the downlink gap. In some embodiments, the downlink channel repetition numbers (e.g., repetitions numbers for the physical downlink control channel (PDCCH), physical downlink shared channel (PDSCH) and/or other downlink channels) may exceed a threshold (e.g., repetitions numbers are higher or lower than the threshold). Physical layer signaling and/or media access control (MAC) layer indication may provide/indicate/specify the downlink channel repetition numbers. If the downlink repetition numbers exceed the threshold, the wireless communication device may initiate one or more possible measurements. In some embodiments, the uplink channel repetition numbers (e.g., repetitions numbers for the physical uplink shared channel (PUSCH) and/or other uplink channels) may exceed a threshold (e.g., repetitions numbers are higher or lower than the threshold). Physical layer signaling and/or MAC layer indication may provide/indicate/specify the uplink channel repetition numbers. If the uplink repetition numbers exceed the threshold, the wireless communication device may initiate one or more possible measurements.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader’s understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIGS. 3-5 illustrate various approaches for utilizing fixed and/or variable time intervals to perform measurements, in accordance with some embodiments of the present disclosure;

FIG. 6 illustrates example approaches for utilizing discontinuous reception (DRX) to perform measurements, in accordance with some embodiments of the present disclosure; and

FIG. 7 illustrates a flow diagram of an example method of enhancing wireless communication device measurements, in accordance with an embodiment of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The following acronyms are used throughout the present disclosure:

| | |
|---|---|
| Acronym | Full Name |
| 3GPP | 3rd Generation Partnership Project |
| 5G | 5th Generation Mobile Networks |
| 5G-AN | 5G Access Network |
| 5G gNB | Next Generation NodeB |
| 5G-GUTI 5G- | Globally Unique Temporary UE Identify |
| AF | Application Function |
| AMF | Access and Mobility Management Function |
| AN | Access Network |
| ARP | Allocation and Retention Priority |
| CA | Carrier Aggregation |
| CM | Connected Mode |
| CMR | Channel Measurement Resource |
| CSI | Channel State Information |
| CQI | Channel Quality Indicator |
| CSI-RS | Channel State Information Reference Signal |
| CRI | CSI-RS Resource Indicator |
| CSS | Common Search Space |
| DAI | Downlink Assignment Index |
| DCI | Downlink Control Information |
| DL | Down Link or Downlink |
| DN | Data Network |
| DNN | Data Network Name |
| ETSI | European Telecommunications Standards Institute |
| FR | Frequency range |
| GBR | Guaranteed Bit Rate |
| GFBR | Guaranteed Flow Bit Rate |
| gNB | Generation NodeB |
| HARQ | Hybrid Automatic Repeat Request |
| MAC-CE | Medium Access Control (MAC) Control Element (CE) |
| MCS | Modulation and Coding Scheme |
| MBR | Maximum Bit Rate |
| MFBR | Maximum Flow Bit Rate |
| NAS | Non-Access Stratum |
| NF | Network Function |
| NG-RAN | Next Generation Node Radio Access Node |
| NR | Next Generation RAN |
| NZP | Non-Zero Power |
| OFDM | Orthogonal Frequency-Division Multiplexing |
| OFDMA | Orthogonal Frequency-Division Multiple Access |
| PCF | Policy Control Function |
| PDCCH | Physical Downlink Control Channel |
| PDSCH | Physical Downlink Shared Channel |
| PDU | Packet Data Unit |
| PUCCH | Physical uplink control channel |
| PUSCH | Physical Uplink Shared Channel |
| PMI | Precoding Matrix Indicator |
| PPCH | Physical Broadcast Channel |
| PRI | PUCCH resource indicator |
| QoS | Quality of Service |
| RAN | Radio Access Network |
| RAN CP | Radio Access Network Control Plane |
| RAT | Radio Access Technology |
| RBG | Resource Block Group |
| RLF | Radio Link Failure |
| RRC | Radio Resource Control |
| RSRP | Reference Signal Received Power |
| RSRQ | Reference Signal Received Quality |
| RV | Redundant Version |
| SIB | System Information Block |
| SM NAS | Session Management Non Access Stratum |
| SMF | Session Management Function |
| SRS | Sounding Reference Signal |
| SS | Synchronization Signal |
| SSB | SS/PBCH Block |
| TB | Transport Block |
| TC | Transmission Configuration |
| TCI | Transmission Configuration Indicator |
| TRP | Transmission/Reception Point |
| UCI | Uplink Control Information |
| UDM | Unified Data Management |
| UDR | Unified Data Repository |
| UE | User Equipment |
| UL | Up Link or Uplink |
| UPF | User Plane Function |
| USS | UE Specific Search Space |

### 1. Mobile Communication Technology and Environment

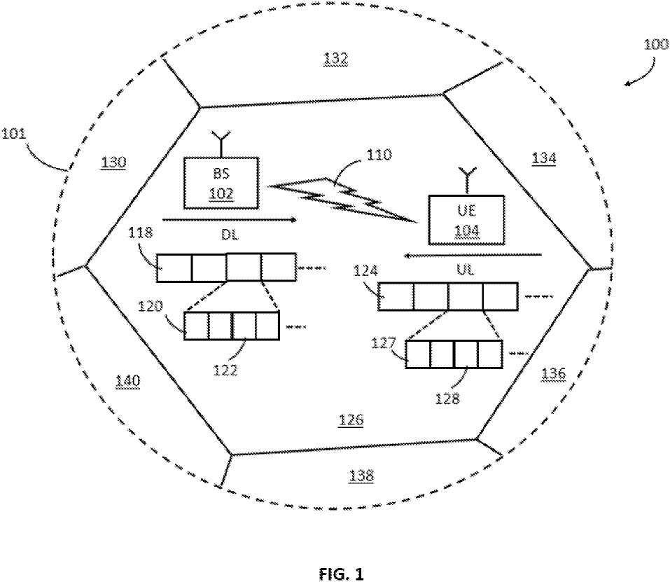

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

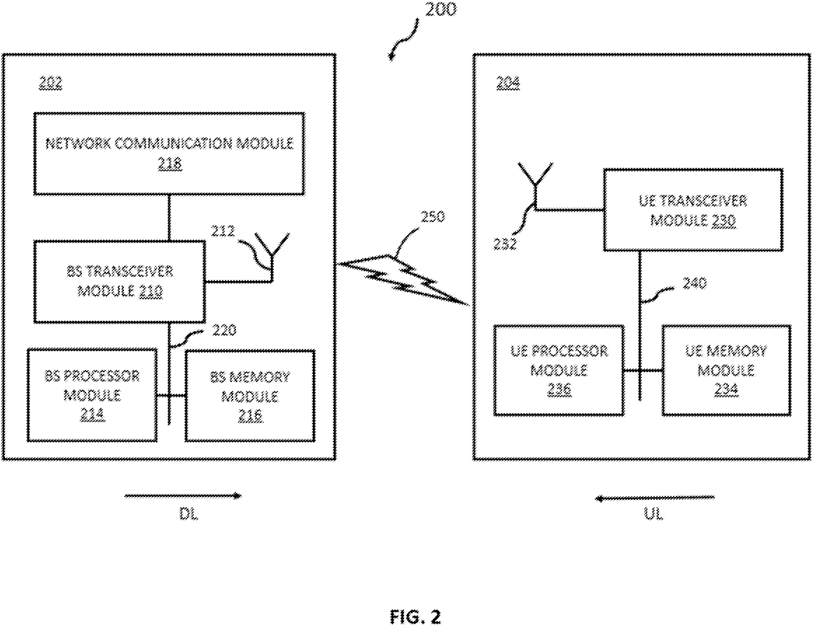

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bidirectional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Enhancing Wireless Communication Device Measurements

The systems and methods presented herein include a novel approach for performing/obtaining wireless communication device (e.g., in connected mode) measurements to improve/increase measurement efficiency by at least 25% (e.g., 35, 45 or other percent) for example. The improvement/increase in measurement efficiency may result in a trade-off between power saving and low/short service interruption time.

In some embodiments, a wireless communication device (e.g., a UE, a terminal, or a served node), may be sensitive/vulnerable to power consumption. If the wireless communication device is sensitive to power consumption, the wireless communication device (e.g., in connected mode) may be unable to perform/obtain measurements for neighbor cells while saving power. During certain procedures (e.g., radio resource control (RRC) reestablishment procedure and/or other procedures triggered by a radio link failure (RLF)), searching for a target cell may take/consume a substantial amount of time. In some embodiments, the search for the target cell may cause/generate/result in service interruption(s) during the procedure. Performing/obtaining/acquiring measurements (e.g., for the neighbor cells) before the procedure(s) may facilitate the search for the target cell and/or reduce the service interruption.

However, performing/obtaining additional measurements while the wireless communication device is in connected mode may cause additional/increased power consumption. The wireless communication device may be unable to predict/anticipate/determine the occurrence of the RLF (or other events). Therefore, the wireless communication device may initiate measurement acquisition soon and/or shortly after the wireless communication device enters/enables connected mode. Once in connected mode, the wireless communication device may continue to measure/evaluate/analyze the quality of the serving cell and/or the neighbor cells until the occurrence of a RLF (or other events). Therefore, it may be beneficial to have solutions with limited measurement overhead and power consumption that ensure the acquisition of valid measurements results.

Performing/acquiring/obtaining measurements in connected mode may impact/affect the transmission of data. In some embodiments, a measurement gap may be defined/configured/determined. The wireless communication device may perform/obtain/acquire one or more measurements during the measurement gap. The wireless communication node may skip/omit the scheduling of one or more uplink (e.g., PUSCH) and/or downlink (e.g., PDSCH or PDCCH) transmissions during the measurement gap. In some embodiments, defining/determining/configuring measurement gaps (or other gaps) in connected mode may increase the complexity. Therefore, the wireless communication node and/or the wireless communication device may utilize/follow one or more approaches to consistently communicate/coordinate one or more parameters. The one or more parameters may comprise the start and/or stop point of the one or more measurements and/or other parameters.

### A. Issue 1: Validity Time of the Measurement Results

In some embodiments, a validity time of the measurement results may reduce/decrease the power consumption of the wireless communication device. The wireless communication device may avoid performing/obtaining/acquiring one or more time measurements within/during the validity time. In some embodiments, one or more restrictions may limit/restrict/regulate the duration of the measurements (e.g., using a timer) and/or the number of measurements (e.g., using a counter). If the validity time is lengthy, the measurement results stored/maintained at the wireless communication device may be dated/irrelevant/obsolete when the RLF (or other events) occurs. If the validity time is short, the measurements results stored by the wireless communication device may be frequent and/or redundant. The wireless communication network may schedule the wireless communication device during the validity time. However, the wireless communication network may be unaware of the start and/or stop time of the validity time. Therefore, the wireless communication node may be unable to schedule the wireless communication device during the validity time.

### B. Issue 2: Notifying the Wireless Communication Node of the Wireless Communication Device’s Measurements in Connected Mode

One or more approaches may be used to communicate/notify/inform the wireless communication node of the wireless communication device’s measurement in connected mode. In some embodiments, the wireless communication device may notify/inform the wireless communication node that one or more measurement conditions have been fulfilled. The wireless communication device may send/transmit the notification to the wireless communication node. Once the wireless communication node receives/obtains the notification, the wireless communication device may initiate/start neighbor cell measurements (or other measurements). The wireless communication node may stop scheduling data for the wireless communication device.

In some embodiments, the wireless communication device and the wireless communication node may negotiate/coordinate one or more rules (e.g., the time duration without data transmissions). If the one or more rules (or conditions) are fulfilled/satisfied, the wireless communication device may initiate the measurements and/or the wireless communication node may stop/terminate the data scheduling for the wireless communication device.

In some embodiments, the wireless communication node may provide/send/transmit an activation indication to the wireless communication device to enable measurements. Once the wireless communication device receives/obtains/has access to the activation indication, the wireless communication device may initiate the measurements. The wireless communication network may stop scheduling data for the wireless communication device.

The one or more aforementioned approaches may require additional air interface signaling exchange, and therefore, may cause overhead. The uplink notification or report may cause the wireless communication device to consume increased/additional power.

### C. Embodiment Set 1: Optimizing the Timing of the Measurements

Embodiment set 1 may relate/associate to issue 1. Embodiment set 1 may provide solutions for optimizing/improving/enhancing the timing for intra-frequency measurements, inter-frequency measurements, specific neighbor cells measurements, radio access technology (RAT) measurements, and/or other measurements. Instead of performing/acquiring/obtaining measurements continuously, the wireless communication device may perform the measurements according to a time interval. The wireless communication device may evaluate/assess/analyze the quality of the serving cell. Responsive to evaluating the quality of the cell, the wireless communication device may start/initiate or restart/reinitiate one or more measurements. In some embodiments, the wireless communication device may use the time interval to evaluate the quality of the cell(s).

### A. Embodiment 1

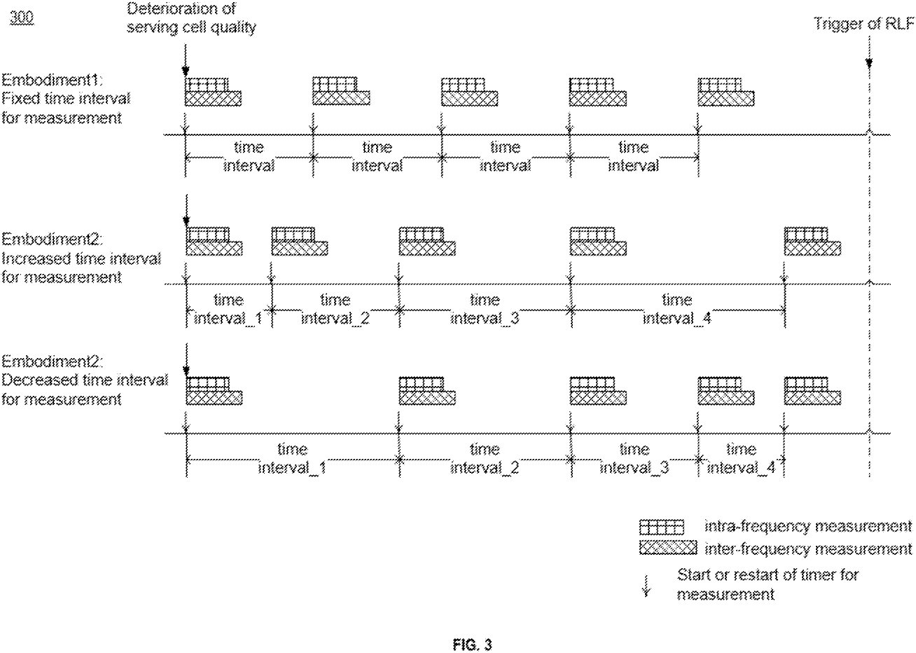

Referring now to FIG. 3, depicted is a representation 300 of an example approach for utilizing fixed and/or variable time intervals to perform measurements. In some embodiments, a fixed time interval may be used/applied/configured for intra-frequency measurements, inter-frequency measurements, and/or other measurements (see FIG. 3, Embodiment 1). Intra-frequency measurements may comprise measurements associated to cells residing on a same/corresponding frequency band of the current serving cell. Inter-frequency measurements may comprise measurements associated to cells residing on a frequency band that is different from the frequency band of the current serving cell. In some embodiments, the wireless communication device may perform/acquire/obtain intra-frequency and/or inter-frequency measurements during a fixed time interval.

The wireless communication node may send/transmit/broadcast the value of the time interval (or other information) for the intra-frequency measurement(s) and/or the inter-frequency measurement(s). The wireless communication node may send the value of the time interval by using a system information message, configuring dedicated signaling, and/or using other messages or signaling. The time interval values of the intra-frequency measurements and the inter-frequency measurements may be the same or different.

The wireless communication node may configure the wireless communication device to perform/obtain/acquire the intra-frequency measurement(s) and/or inter-frequency measurement(s). The wireless communication device may perform the intra-frequency measurement(s) and/or inter-frequency measurement(s) during the time interval. The wireless communication device may stop/terminate the measurements if at least one condition of a list of conditions is fulfilled/satisfied. The list of conditions may include at least one of the following conditions:
The wireless communication device may obtain/acquire/receive the measurement results for one or more neighbor cells in the same frequency and/or different frequencies.
The wireless communication device may obtain/acquire/receive the measurement results for a subset of neighbor cells by UE implementation (e.g., in the same frequency and/or different frequencies).
The wireless communication device may obtain the measurement results for the configured neighbor cells (e.g., in the same frequency and/or different frequencies) if the wireless communication network provides/indicates/specifies a neighbor cell list.
The wireless communication device may obtain the measurement results for the neighbor cells with the strongest/highest signal strength (e.g., in the same frequency and/or different frequencies).
The wireless communication device may obtain the measurement results for the neighbor cells with a certain value indicating that cell quality (e.g., associated with one or more of the neighbor cells) is higher/greater than the quality of the serving cell.
   The certain value may comprise the value of a measurement result, the average value of a plurality of measurement results, the maximum value of a plurality of measurements results, and/or other values associated to the measurement results. The specific value may be hard-coded, configured by the network, and/or determined by the wireless communication device implementation.

The wireless communication device may begin/initiate/start the intra-frequency and/or inter-frequency measurements once the following time interval begins.

### B. Embodiment 2

In some embodiments, the wireless communication device may apply/use an increasing and/or a decreasing time interval to perform intra-frequency and/or inter-frequency measurements. The wireless communication device may perform the intra-frequency and/or inter-frequency measurements during a variable time interval. In some embodiments, the variable time interval may gradually increase/lengthen compared to the previous time interval (see FIG. 3, Embodiment 2). For example, time_interval 2 may be larger than the previous time interval (e.g., time _interval1). In some embodiments, the variable time interval may gradually decrease/shorten compared to the previous time interval (see FIG. 3, Embodiment 2). For example, time _interval 4 may be shorter than the previous time interval (e.g., time_interval3).

The wireless communication node may send/transmit/broadcast the initial value of the time interval (or other information) for the intra-frequency and/or inter-frequency measurement(s). The wireless communication node may send the initial value of the time interval by using a system information message, configuring dedicated signaling, and/or using other messages or signaling. The wireless communication node may indicate/specify/provide access to the quantity/amount that is used to modify/alter the initial time interval. For example, the initial value of the time interval may be modified using the provided quantity/amount to generate a gradually increasing time interval (e.g., add or multiply the quantity). In another example, the initial value of the time interval may be modified using the provided quantity to generate a gradually decreasing time interval (e.g., subtract or divide the quantity). In some embodiments, the values associated with the variable time intervals (e.g., initial value and/or modifying quantity/amount) may be the same (or different) for the intra-frequency measurements and the inter-frequency measurements.

The wireless communication node may configure the wireless communication device to perform/obtain/acquire the intra-frequency measurement(s) and/or inter-frequency measurement(s). The wireless communication device may perform the intra-frequency measurement(s) and/or inter-frequency measurement(s) during the time interval. The wireless communication device may stop/terminate the measurements if at least one condition of a list of conditions is fulfilled/satisfied. The list of conditions may include at least one of the following conditions:
The wireless communication device may obtain/acquire/receive the measurement results for one or more neighbor cells in the same frequency and/or different frequencies.
The wireless communication device may obtain/acquire/receive the measurement results for a subset of neighbor cells by UE implementation (e.g., in the same frequency and/or different frequencies).
The wireless communication device may obtain the measurement results for the configured neighbor cells (e.g., in the same frequency and/or different frequencies) if the wireless communication network provides/indicates/specifies a neighbor cell list.
The wireless communication device may obtain the measurement results for the neighbor cells with the strongest/highest signal strength (e.g., in the same frequency and/or different frequencies).
The wireless communication device may obtain the measurement results for the neighbor cells with a certain value indicating that cell quality (e.g., associated with one or more of the neighbor cells) is higher/greater than the quality of the serving cell.
   The certain value may comprise the value of a measurement result, the average value of a plurality of measurement results, the maximum value of a plurality of measurements results, and/or other values associated to the measurement results. The specific value may be hard-coded, configured by the network, and/or determined by the wireless communication device implementation.

The wireless communication device may begin/initiate/start the intra-frequency and/or inter-frequency measurements once the following time interval begins.

The following time interval may be longer/larger than the previous time interval by adding a quantity/amount/value to the previous time interval (e.g., one or more steps if the wireless communication node indicates a quantity/step value for increasing the time interval to the previous interval). In some embodiments, the following time interval may be shorter/smaller than the previous time interval by subtracting the quantity to the previous time interval (e.g., one or more steps if the wireless communication node indicates a quantity for decreasing the time interval to the previous interval).

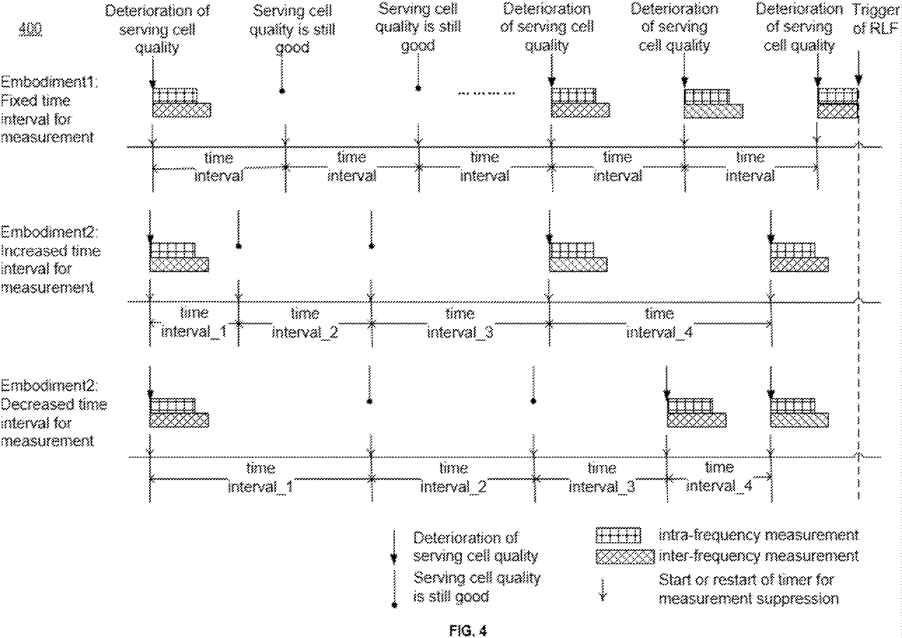

Referring now to FIG. 4, depicted is a representation 400 of an example approach for utilizing fixed and/or variable time intervals to perform measurements. In some embodiments, the quality of the service cell may fluctuate/vary. If the quality of the service cell fluctuates, the wireless communication device may determine to omit/skip neighbor cell measurements. In some embodiments, the wireless communication device may perform neighbor cell measurements in response to a decrease of the quality of the serving cell. The quality of the serving cell may decrease below a certain threshold. For example, responsive to determining the quality of the cell has decreased below a threshold, the wireless communication device may perform neighbor cell measurements.

If the wireless communication device performs one or more measurements in response to a decrease in cell quality, the wireless communication device may perform the measurements intermittently/sporadically/irregularly. For example, in response to determining that a serving cell quality deteriorates, the wireless communication device may perform intra-frequency and/or inter-frequency measurements (e.g., at the starting point of time interval_1). Once the serving cell quality improves (e.g., above a certain threshold), the wireless communication device may stop performing the measurements (e.g., before, during, or after time interval_2 and time interval_3). If the serving cell quality deteriorates once again, the wireless communication device may perform intra-frequency and/or inter-frequency measurements (e.g., at the starting point of time interval_4). If the serving cell quality changes/fluctuates/varies, the increasing and/or decreasing time intervals may reduce the number of neighbor cell measurements. The increasing and/or decreasing time intervals may ensure the wireless communication device can acquire/perform/obtain neighbor cell measurements prior to the occurrence of a RLF (or other events).

### C. Embodiment 3

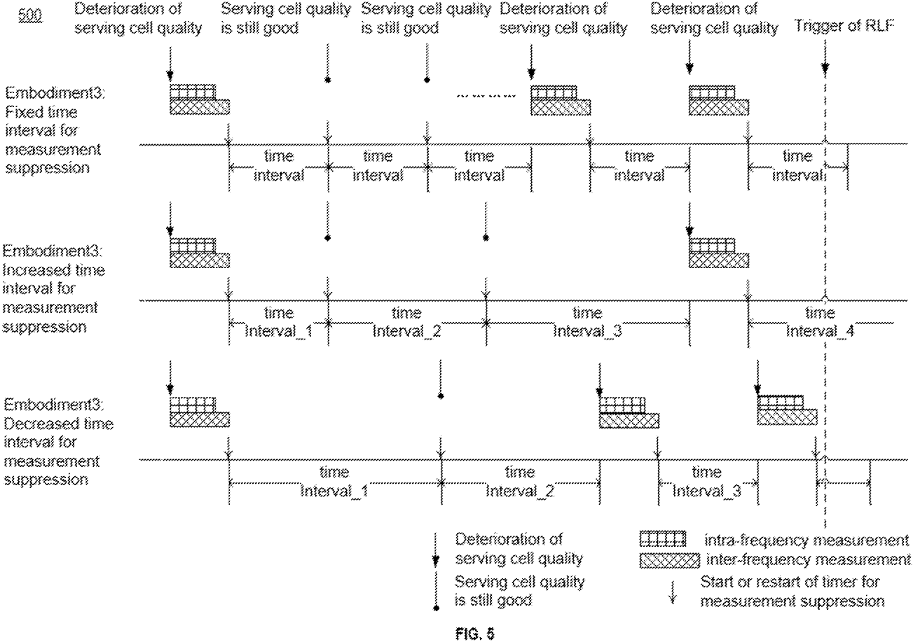

Referring now to FIG. 5, depicted is a representation 500 of an example approach for utilizing fixed and/or variable time intervals to perform measurements. The operations and functionalities described herein may be performed by any one or more of the components and/or operations described in connection with FIGS. 3 - 4 (e.g., embodiment 2). In some embodiments, the starting point of the time interval(s) may be different. For example, the wireless communication device may start or restart a timer after completing/finalizing an intra-frequency and/or inter-frequency neighbor cell measurement. Therefore, the time interval may initiate/start after the intra-frequency and/or inter-frequency measurement finalizes/completes. The time interval may be referred to as a time duration for suppressing measurements. For example, the deterioration of a serving cell quality may trigger/cause the wireless communication device to perform one or more measurements. Once the measurements are completed, the timer for suppressing measurements may start (or restart) (e.g., at the beginning of time interval_1, time interval_2 and/or time interval_3). If the serving cell quality deteriorates once again, the wireless communication device may perform/acquire additional measurements (e.g., at the end of time interval_3 and/or time interval _2). Once the additional measurements are completed/finalized, the time duration for suppressing measurements may start (or restart) (e.g., at the beginning of time interval_4).

### D. Embodiment 4

The operations and functionalities described herein may be performed by any one or more of the components and/or operations described in connection with FIGS. 3-5 (e.g., embodiment 1, embodiment 2 and/or embodiment 3). Embodiment 4 may include similar time interval settings as those described in connection with embodiment 1. For example, the wireless communication device may use/apply a fixed time interval when performing/acquiring the measurement(s). The measurement(s) may comprise one or more measurements of the radio quality of the cell (e.g., reference signal received power (RSRP) and/or reference signal received quality (RSRQ) of the cell). In some embodiments, the wireless communication device may perform/acquire/obtain the one or more measurements during the fixed time interval. The wireless communication node may send/transmit/broadcast the value of the time interval (or other information) for the measurement(s) of the neighbor cells. The wireless communication node may send the value of the time interval by using a system information message, configuring dedicated signaling, and/or using other messages or signaling. In some embodiments, the wireless communication node may broadcast/transmit/configure/determine a neighbor cell list. The neighbor cell list may comprise one or more neighbor cells.

In some embodiments, the wireless communication node may configure the wireless communication device to perform the measurement(s) for the neighbor cells. During the time interval, the wireless communication device may perform the measurement(s) for the neighbor cell(s). The wireless communication device may stop/finalize the measurement(s) responsive to obtaining/receiving the measurement result(s) of the neighbor cell(s). During the next/following time interval, the wireless communication device may perform the measurement(s) for the same neighbor cell(s) and/or other neighbor cell(s).

### E. Embodiment 5

The operations and functionalities described herein may be performed by any one or more of the components and/or operations described in connection with FIGS. 3-5 (e.g., embodiment 1, embodiment 2 and/or embodiment 3). In some embodiments, the wireless communication device may use/apply the increasing or decreasing time intervals to perform measurements for the neighbor cells. The wireless communication device may perform one or more measurements for the neighbor cell(s) during the time intervals (e.g., increasing or decreasing time intervals). The time intervals may gradually increase or decrease compared to the previous time interval (e.g., time interval_2 may increase/decrease compared to time interval_1).

The wireless communication node may send/transmit/broadcast/provide access to the initial value of the time interval and (or other information) for the measurement(s) of the neighbor cells. The wireless communication node may indicate/specify/send/provide access to the quantity/amount that is used to modify/alter the initial time interval. The wireless communication node may send the value of the time interval by using a system information message, configuring dedicated signaling, and/or using other messages or signaling. In some embodiments, the wireless communication node may broadcast/transmit/configure/determine a neighbor cell list. In some embodiments, the wireless communication device may perform/obtain the measurement(s) for the neighbor cell(s) using a similar process as those described in connection with embodiment 2 and/or embodiment 3.

### F. Embodiment 6

The operations and functionalities described herein may be performed by any one or more of the components and/or operations described in connection with FIGS. 3-5 (e.g., embodiment 2 and/or embodiment 3). In some embodiments, the increasing/lengthening or decreasing/shortening time interval may depend/rely on the measurement results. The length of one or more consecutive time intervals may correspond to variable length time intervals (e.g., depending on the measurement results).
If the number of the measurement results and/or the quality of the measurement results meet or exceed an expectation, the wireless communication device may increase the time interval. The wireless communication network may configure/determine the expectation. The expectation may comprise a hard-coded value.
If the number of the measurement results and/or the quality of the measurements results fail to meet or exceed the expectation, the wireless communication device may decrease the time interval.

### D. Embodiment Set 2: Reducing Air Interface Signaling Overhead

Embodiment set 2 may relate/associate to issue 2. Embodiment set 2 may provide solutions for reducing/optimizing/decreasing air interface signaling overhead between the wireless communication device and the wireless communication node. The notification of starting and/or stop points of the measurements may introduce/cause the air interface signaling overhead.

### A. Embodiment 0

In some embodiments, the wireless communication device may notify/inform the wireless communication node of the measurement(s) at the starting point of each measurement (e.g., intra-frequency measurements, inter-frequency measurements, specific neighbor cell measurements, radio access technology (RAT) measurements, and/or other measurements). In some embodiments, the wireless communication node may enable the wireless communication device at the starting point of each measurement. The wireless communication device may inform the wireless communication node of the measurement(s) at the stop point of each measurement.

In some embodiments, the communication between the wireless communication device and the wireless communication node may be synchronized/coordinated via a configured time duration. For example, at the starting point of each measurement, the wireless communication device and the wireless communication node may determine that the measurement(s) are completed/finalized within the time duration. In some embodiments, the wireless communication device may fail to complete/finalize the measurement(s) within the time duration. If the wireless communication device fails to complete the measurements, the wireless communication device may discontinue the measurements. If the wireless communication device completes the measurements, the wireless communication device may schedule a transmission (e.g., UL or DL transmission) at the end of the configured time duration.

### B. Embodiment 1

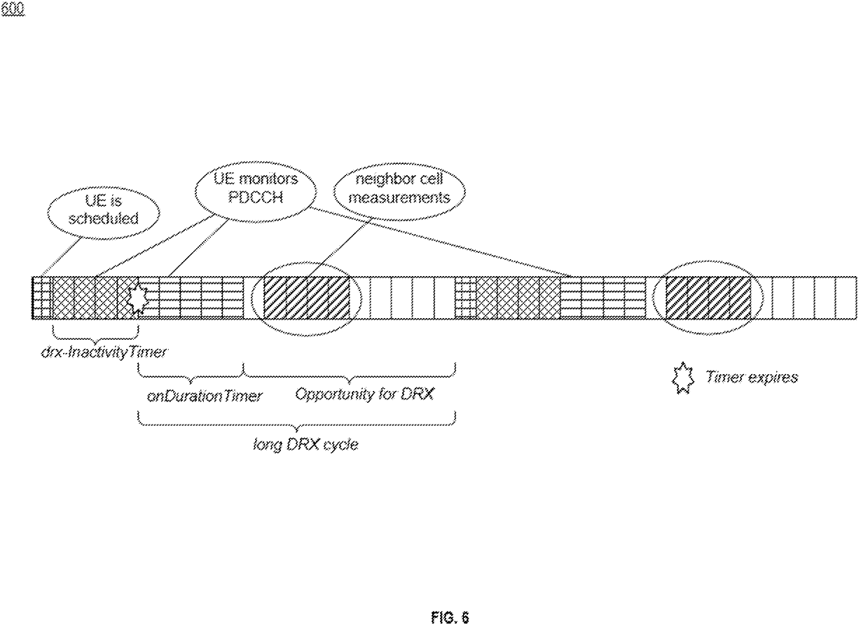

Referring now to FIG. 6, depicted is a representation 600 of an example approach for utilizing discontinuous reception (DRX) to perform measurements. In some embodiments, the wireless communication device may use connected mode DRX to perform/obtain/acquire one or more measurements. The wireless communication device may perform the one or more measurements during a long DRX cycle. For example, the wireless communication device may perform the measurements after an onDurationTimer (or other timers) expires and/or during/within the opportunity for DRX.

In some embodiments, the wireless communication device may follow/use/implement/enable any one or more of the components and/or operations discussed in connection with embodiments 1, 2, and/or 3 in embodiment set 2. The wireless communication device may use embodiments 1 to 3 to evaluate the serving cell quality and/or determine whether (and/or when) to initiate the possible measurements. The wireless communication device may perform the measurements within/during the overlap between the configured time interval and the DRX opportunity in the long DRX cycle. The wireless communication device may use/implement/follow the operations discussed in connection with embodiments 1 and/or 2 to stop/finalize the measurements and/or store/maintain the measurement results. In some embodiments, the wireless communication device may omit/skip notifying the wireless communication node of the starting and/or stop measurements.

### C. Embodiment 2

In some embodiments, the wireless communication device may use a downlink gap to perform/obtain/acquire the measurements. For example, the wireless communication device may perform one or more measurements during the downlink gap (e.g., the non-scheduled subframes without uplink and/or downlink transmissions according to the starting subframe configuration for a narrowband physical downlink control channel (NPDCCH) UE-specific search space).

The wireless communication device may follow/use/implement/enable any one or more of the components and/or operations discussed in connection with embodiments 1, 2, and/or 3 in embodiment set 2. The wireless communication device may use embodiments 1 to 3 to evaluate the serving cell quality and/or determine whether (and/or when) to initiate the possible measurements. The wireless communication device may perform the measurements within/during the overlap between the configured time interval and the downlink gap. The wireless communication device may use/implement/follow the operations discussed in connection with embodiments 1 and/or 2 to stop/finalize the measurements and/or store/maintain the measurement results.

### E. Embodiment Set 3: Downlink and Uplink Applications

### A. Embodiment 1

In some embodiments, the wireless communication node may send/transmit/broadcast at least one threshold to evaluate/analyze/quantify service cell quality. The wireless communication node may send the threshold(s) by using a system information message, configuring dedicated signaling, and/or using other messages or signaling. The threshold(s) may be compared to/against one or more scheduling parameters, resource parameters, and/or statistical parameters. The parameters may comprise repetition number(s), modulation order, transport block size, transmitted NACK, and/or other parameters.

In some embodiments, physical layer signaling, a MAC layer indication, and/or other signaling/indicators may provide/specify/indicate the downlink repetition numbers. The downlink repetition numbers may include repetition numbers for PDCCH, repetition numbers for PDSCH, and/or other downlink channel repetition numbers. For example, the MAC layer indication (or other indicators) may specify the PDCCH repetition number(s). The wireless communication device may determine the repetition number(s) exceed (or are below) the threshold. If the repetition numbers exceed the threshold, the wireless communication device may determine the serving cell quality deteriorates/degrades. Responsive to the determination, the wireless communication device may initiate one or more measurements (e.g., intra-frequency measurements, inter-frequency measurements, specific neighbor cells measurements, RAT measurements, and/or other measurements) in connected mode.

### B. Embodiment 2

In some embodiments, the wireless communication node may send/transmit/broadcast at least one threshold to evaluate/analyze/quantify service cell quality. The wireless communication node may send the threshold(s) by using a system information message, configuring dedicated signaling, and/or using other messages or signaling. The threshold(s) may be compared to/against one or more scheduling parameters, resource parameters, and/or statistical parameters. The parameters may comprise repetition number(s), modulation order, transport block size, transmitted NACK, and/or other parameters.

In some embodiments, physical layer signaling, a MAC layer indication, and/or other signaling/indicators may provide/specify/indicate the uplink repetition numbers. The uplink repetition numbers may include repetition numbers for PUSCH and/or other uplink channel repetition numbers. For example, the physical layer signaling (or other signaling) may specify the PUSCH repetition number(s). The wireless communication device may determine the repetition number(s) exceed (or are below) the threshold. If the repetition numbers exceed the threshold, the wireless communication device may determine the serving cell quality deteriorates/degrades. Responsive to the determination, the wireless communication device may initiate one or more measurements (e.g., intra-frequency measurements, inter-frequency measurements, specific neighbor cells measurements, RAT measurements, and/or other measurements) in connected mode.

### F. Methods of Enhancing Wireless Communication Device Measurements

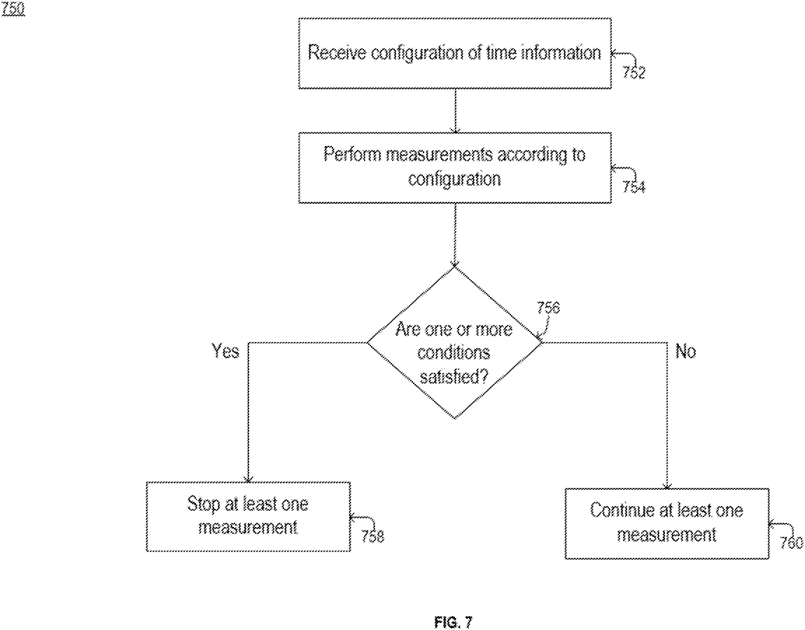

FIG. 7 illustrates a flow diagram of a method 750 of enhancing wireless communication device measurements. The method 750 may be implemented using any of the components and devices detailed herein in conjunction with FIGS. 1-6. In overview, the method 750 may include receiving configuration of time information (752). The method 750 may include performing measurements according to configuration (754). The method 750 may include determining whether one or more conditions are satisfied (756). The method 750 may include stopping at least one measurement (758). The method 750 may include continuing at least one measurement (760).

Referring now to operation (752), and in some embodiments, a wireless communication device (e.g., UE) may receive/obtain a configuration of time information. The wireless communication device may receive/have access to a configuration of time information for measurements to be performed by the wireless communication device. The wireless communication node (e.g., gNB or base station) may send/transmit/broadcast/provide the configuration to the wireless communication device. The time information for the measurements may include a time interval between at least two measurements, a time interval or duration without measurements, and/or a time duration for at least one of the measurements. The configuration may indicate/specify/instruct/inform to use a fixed time interval between the measurements to be performed by the wireless communication device.

In some embodiments, the configuration may indicate to use a time interval that increases/lengthens or decreases/shortens between successive measurements to be performed by the wireless communication device. In some embodiments, the wireless communication device may configure the time interval to increase or decrease between successive measurements. The wireless communication device may configure the time interval according to a result of at least one prior measurement of the measurements. The measurement results may indicate/influence/impact/affect the change in length/size of the time interval. For example, the quality of the measurements results may cause the wireless communication device to increase the time interval. In another example, the number of the measurement results may cause the time interval to decrease. In some embodiments, the wireless communication device may initiate/start/trigger a measurement for each time interval in which a quality of a serving cell fails to satisfy/fulfill/meet/exceed a threshold value.

Referring now to operation (754), and in some embodiments, a wireless communication device may perform/obtain/acquire one or more measurements. In some embodiments, the wireless communication device may perform at least one of the measurements according to the configuration. The configuration may indicate/specify/instruct to start a next time interval at a time instance at which a measurement of a current time interval is complete. The wireless communication device may start and/or restart a timer for the next time interval, at the time instance at which the measurement of the current time interval is complete. In some embodiments, the measurements may comprise intra-frequency measurements, inter-frequency measurements, measurement of neighboring cells, measurement of radio access technology (RAT), and/or other measurements.

In some embodiments, the wireless communication device may initiate/start one of the measurements according to the configuration, during an opportunity for discontinuous reception (DRX) in a DRX cycle (e.g., in a long DRX cycle after an onDurationTimer expires) and/or a downlink gap. The wireless communication device may perform one of the measurements within/during the overlap between the configured time interval (e.g., fixed, increasing, or decreasing) and the opportunity for DRX. In some embodiments, the wireless communication device may initiate one of the measurements according to the configuration, and during a downlink gap. The wireless communication device may perform/initiate one of the measurements within/during the overlap between the configured time interval (e.g., fixed, increasing or decreasing) and the downlink gap.

The wireless communication device may receive/obtain at least one threshold value (e.g., threshold for evaluating/comparing/analyzing service cell quality) from the wireless communication node. The wireless communication node may send/transmit/broadcast/provide access to the at least one threshold value. In some embodiments, the wireless communication device may perform/acquire/obtain the measurements according to configuration. The wireless communication device may perform the measurements when at least one of a channel repetition number of a channel (e.g., uplink or downlink), one or more scheduling parameters and/or one or more statistical parameters exceed the threshold value(s). The scheduling and/or statistical parameters may comprise a repetition number, a modulation order, a transport block size, a transmitted NACK, and/or other parameters.

Referring now to operation (756), and in some embodiments, the wireless communication device may determine whether one or more conditions are satisfied/fulfilled. In some embodiments, the wireless communication device may determine to stop or start at least one of the measurements if one or more conditions are satisfied. The one or more conditions that are satisfied may comprise that the wireless communication device obtains/receives measurement results for all neighbor cells. The one or more conditions that are satisfied may comprise that the wireless communication device obtains/receives measurement results for some of the neighbor cells (e.g., identified by the wireless communication device). The condition(s) may comprise that the wireless communication device obtains measurement results for neighbor cells identified or configured by the wireless communication device. The condition(s) may comprise that the wireless communication device obtains measurement results for neighbor cells with strongest/highest signal strengths (e.g., in the same frequency and/or different frequencies). The condition(s) may comprise that the wireless communication device obtains measurement results for neighbor cells with a specific value that is higher/greater than the quality of the serving cell. The specific value may comprise the value of a measurement result, the average value of a plurality of measurement results, the maximum value of a plurality of measurements results, and/or other values associated to the measurement results. The specific value may be hard-coded, configured by the network, and/or determined by the wireless communication device implementation.

Referring now to operation (758) and (760), and in some embodiments, the wireless communication device may stop or continue at least one measurement. Responsive to determining that one or more conditions are satisfied/fulfilled, the wireless communication device may determine to stop or start at least one of the measurements. Responsive to determining that at least one condition is unsatisfied/unfulfilled, the wireless communication device may continue at least one of the measurements. For example, the wireless communication node may configure the wireless communication device to perform intra-frequency and/or inter-frequency measurements during a time interval (e.g., fixed, increasing, or decreasing time interval). If the wireless communication device determines at least one condition is satisfied, the wireless communication device may stop/suspend the intra-frequency and/or inter-frequency measurements. Otherwise, the wireless communication device may continue to perform/acquire/obtain the measurements.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a wireless communication device from a wireless communication node, a configuration of time information for measurements to be performed by the wireless communication device; and
performing, by the wireless communication device, at least one of the measurements according to the configuration.

2. The method of claim 1, wherein the measurements comprise at least one of: intra-frequency measurement, inter-frequency measurement, measurement of neighboring cells, or measurement of radio access technology (RAT).

3. The method of claim 1, wherein the configuration indicates to use a fixed time interval between the measurements to be performed by the wireless communication device.

4. The method of claim 1, wherein the configuration indicates to use a time interval that increases or decreases between successive measurements to be performed by the wireless communication device.

5. The method of claim 3, comprising:
initiating, by the wireless communication device, a measurement for each time interval in which a quality of a serving cell fails to satisfy a threshold value.

6. The method of claim 1, wherein a start of a next time interval is at a time instance at which a measurement of a current time interval is complete.

7. The method of claim 6, comprising:
starting or restarting, by the wireless communication device, a timer for the next time interval, at the time instance at which the measurement of the current time interval is complete.

8. The method of claim 1, comprising:
initiating, by the wireless communication device, one of the measurements according to the configuration, during an opportunity for discontinuous reception (DRX) in a DRX cycle.

9. The method of claim 1, comprising:
initiating, by the wireless communication device, one of the measurements according to the configuration, and during a downlink gap.

10. The method of claim 1, comprising:
receiving, by the wireless communication device from the wireless communication node, at least one threshold value; and
performing, by the wireless communication device according to the configuration, the measurements when at least one parameter exceeds the at least one threshold value,
wherein the at least one parameter comprises at least one of: a repetition number, a modulation order, a transport block size, or a number of transmitted negative-acknowledgement (NACK) messages.

11. The method of claim 1, comprising:
determining, by the wireless communication device, to stop or start at least one of the measurements if one or more conditions are satisfied,
wherein the one or more conditions that are satisfied comprise at least one of:
the wireless communication device obtains measurement results for all neighbor cells,
the wireless communication device obtains measurement results for some of the neighbor cells identified by the wireless communication device,
the wireless communication device obtains measurement results for neighbor cells identified or configured by the wireless communication device,
the wireless communication device obtains measurement results for neighbor cells with strongest signal strengths, or
the wireless communication device obtains measurement results for neighbor cells which indicate that a cell quality associated with the neighbor cells is higher than a quality of a serving cell of the wireless communication device.

12. The method of claim 1, wherein the time information for the measurements includes at least one of:
time interval between at least two of the measurements,
time interval or duration in which there is no measurement, or
time duration for at least one of the measurements.

13. The method of claim 4, wherein the time interval is configured to increase or decrease between successive measurements, according to a result of at least one prior measurement of the measurements.

14. A method, comprising:
sending, by a wireless communication node to a wireless communication device, a configuration of time information for measurements to be performed by the wireless communication device,
wherein the wireless communication device performs at least one of the measurements according to the configuration.

15. The method of claim 14, wherein the measurements comprise at least one of: intra-frequency measurement, inter-frequency measurement, measurement of neighboring cells, or measurement of radio access technology (RAT).

16. The method of claim 14, wherein the configuration indicates to use a fixed time interval between the measurements to be performed by the wireless communication device.

17. The method of claim 14, wherein the configuration indicates to use a time interval that increases or decreases between successive measurements to be performed by the wireless communication device.

18. The method of claim 16, wherein the wireless communication device initiates a measurement for each time interval in which a quality of a serving cell fails to satisfy a threshold value.

19. A wireless communication device, comprising:
at least one processor configured to:
receive, via a receiver from a wireless communication node, a configuration of time information for measurements to be performed by the wireless communication device; and
perform at least one of the measurements according to the configuration.

20. A wireless communication node, comprising:
at least one processor configured to:
send, via a transmitter to a wireless communication device, a configuration of time information for measurements to be performed by the wireless communication device,
wherein the wireless communication device performs at least one of the measurements according to the configuration.
